(19) United States
(12) Patent Application Publication
(10) Pub. No.: US 2008/0295869 A1
(43) Pub. Date: Dec. 4, 2008

(54) APPARATUS AND METHOD FOR CLEANING OUTDOOR SURFACES

(75) Inventors: Jim Schriver, Pittsburgh, PA (US); Robert T. Pogue, Pittsburgh, PA (US); Richard A. Beuke, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/757,582

(22) Filed: Jun. 4, 2007

(51) Int. Cl. B08B 3/04; A47L 13/17

(52) U.S. Cl. 134/34; 15/244.2

(57) ABSTRACT

The present invention is directed to an apparatus and method for cleaning outdoor surfaces. The apparatus includes a cleaning element attached to a handle which also supports a reservoir for cleaning fluid. The cleaning element includes absorbent and scrubbing layers structured to clean various types of outdoor surfaces. A cleaning fluid is applied by a liquid delivery system in fluid communication with the cleaning element to the outdoor surface to be cleaned and the outdoor surface is wiped with the cleaning apparatus.

### FIELD OF THE INVENTION

The present invention is directed to an apparatus and method for cleaning outdoor surfaces.

### BACKGROUND OF THE INVENTION

Various cleaning apparatuses and methods are known in the art for cleaning outdoor surfaces. Many of these methods consist of applying water or a cleaning fluid by hand to pour or squirt it from a container onto the surface to be cleaned and then using a cleaning apparatus such as a mop, broom or brush to further apply and/or wipe off the solution. These and related methods can be messy and ineffective, particularly when thoroughly cleaning a surface such as a deck having a generally planar surface with intentional gaps between elements, such as boards. Using a brush for difficult to clean opposed surfaces of the boards in the gaps of the decks can be time consuming and awkward. Further, these and related methods can be inefficient relative to the amount of water and/or cleaning fluid used in cleaning the surface.

Various cleaning apparatuses and methods which employ a means of applying water or cleaning fluid and wiping the surface with the same cleaning apparatus are known for cleaning indoor hard surfaces. These apparatuses may not be as effective for cleaning outdoor surfaces which are often more porous, less uniform and have significantly more dirt and grime build-up than indoor hard surfaces.

Improved methods and apparatuses for cleaning outdoor surfaces are therefore desired.

### SUMMARY OF THE INVENTION

The present invention relates to an apparatus for cleaning an outdoor surface comprising a handle; a removable cleaning element mounted to one end of the handle structured and arranged to clean the outdoor surface; a reservoir for storing cleaning fluid mounted to the handle; and a tube in fluid communication between the reservoir and the removable cleaning element. The removable cleaning element includes an absorbent layer and a scrubbing layer covering at least a portion of the absorbent layer.

The invention is also directed to a method for cleaning an outdoor surface comprising applying a cleaning fluid to the outdoor surface to be cleaned; and wiping the outdoor surface with a cleaning apparatus that comprises a handle and a removable cleaning element structured and arranged to clean the outdoor surface, wherein the cleaning fluid is applied by a liquid delivery system in fluid communication with the cleaning element.

### BRIEF DESCRIPTION OF THE DRAWINGS

FIG. 1 is a perspective view of a cleaning apparatus made in accordance with the present invention.

FIGS. 2, 3 and 4 are perspective views of cleaning elements made in accordance with the present invention.

### DETAILED DESCRIPTION OF THE INVENTION

The present invention is directed to an apparatus and method for cleaning outdoor surfaces. As used herein, the term “outdoor surface” is distinct from an indoor surface and includes exposed surfaces such as decks, driveways, patios and the like which are exposed to sun, rain, wind and/or other weather elements. The apparatus includes a handle, a removable cleaning element structured and arranged to clean the outdoor surface and a liquid delivery system. The method includes applying a cleaning fluid to the outdoor surface to be cleaned and wiping the outdoor surface with the cleaning apparatus.

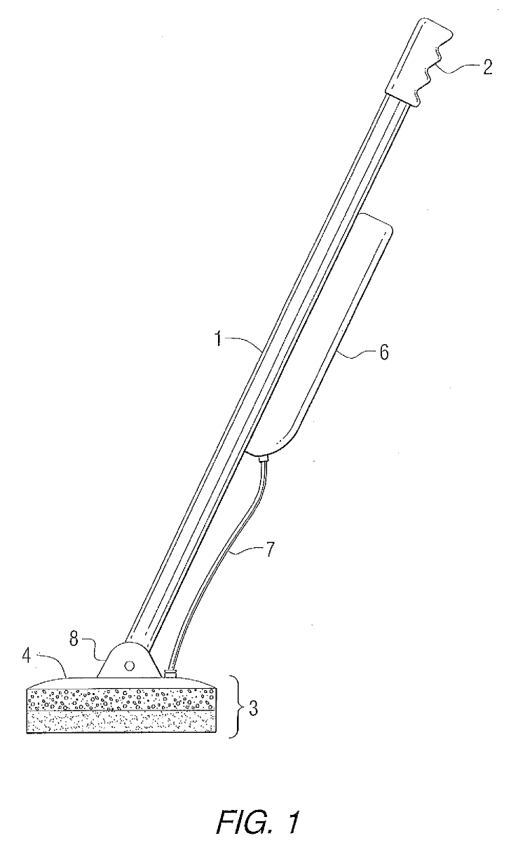

Referring to FIG. 1, a cleaning apparatus made in accordance with the present invention is illustrated. The apparatus can include a handle 1 having a hand grip 2 attached at one end and a cleaning element 3 attached at the other end by a support head 4. The support head can be attached to the handle by various means, for example a universal joint 8. A liquid delivery system 5 which includes a reservoir 6 and a tube 7 can be mounted to the handle.

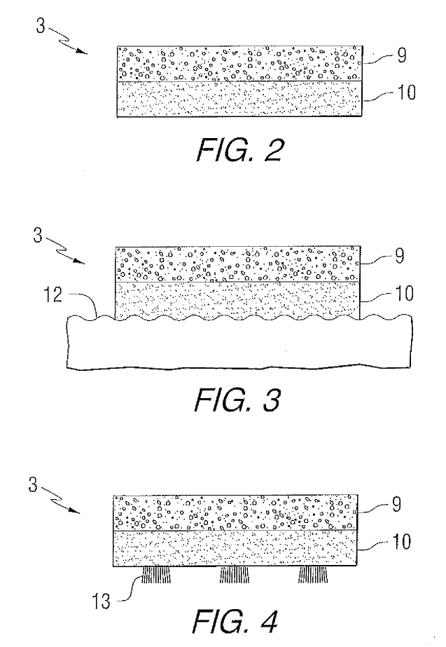

Referring to FIG. 2, the outdoor surface cleaning element can include an absorbent layer 9 and a scrubbing layer 10. Referring to FIG. 3, the scrubbing layer 11 can conform to irregular surfaces 12. Referring to FIG. 4, a plurality of bristles 13 may extend outward from the surface of the scrubbing layer 14.

The handle 1 of the apparatus may include an elongated durable material such as but not limited to wood, metal, plastic and the like. The handle 1 may include a hand grip 2 at one end thereof. Suitable materials for the hand grip 2 may include but are not limited to metal, plastic; rubber and the like. The length of the handle 1 may vary. In an embodiment, for ease of use, the handle 1 may be of a length corresponding to a conventional mop. In another embodiment, the length of the handle 1 may be adjustable such that the handle 1 can be extended for difficult to reach areas.

The handle 1 of the apparatus may include a support head 4 at the other end to which the cleaning element 3 may be attached in a manner such that the cleaning element 3 is releasable and removable from the support head 4. The support head 4 may be attached to the handle 1 using a wide variety of known means, for example, a universal joint 8. In an embodiment, the support head 4 may be attached to the handle 1 by a means that allows the cleaning element 3 to pivot.

The cleaning element 3 can be attached to the support head 4 by any suitable means known in the art so long as the cleaning element 3 remains affixed during the cleaning process and can be removed, or a portion removed, and replaced with a new cleaning element 3. Non-limiting examples of suitable attaching means include clamps, hooks and adhesives such as VELCRO which is commercially available from Velcro Industries, B.V.

As used herein, terms such as “attached to” or “mounted to” and the like mean positioned or supported on but not necessarily in direct surface contact with. For example, the cleaning element “attached to” a support head or “mounted to” the handle of the cleaning apparatus does not preclude the presence of one or more other materials located between the cleaning element and the support head or the cleaning element and the handle.

As shown in FIG. 2, the cleaning element 3 may include an absorbent material 9 having a capacity for absorbing cleaning fluid, a scrubbing material 10, or a combination thereof. The absorbent material 9 may also be capable of retaining at least a portion of absorbed fluid and soil under in-use pressures to reduce or avoid “squeeze-out” of the absorbed fluid and soil. The absorbent material 9 may include any materials capable of absorbing and retaining liquid during use. The absorbent material 9 may include a wide variety of water-insoluble, but water-swellable polymers capable of absorbing fluids. The absorbent material 9 may include one layer or multiple layers.

In an embodiment, the cleaning element 3 may include two discrete members; for example an absorbent layer 9 and a scrubbing layer 10. In a further embodiment, the scrubbing layer 10 may be a first layer of the cleaning element 3 which is in contact with the surface to be cleaned and the absorbent layer 9 may be a second layer which is at least partially connected to the first layer 10. The two layers may be at least partially connected by any known means such as but not limited to an adhesive material.

The material suitable for the scrubbing layer 10 should be sufficiently durable such that it will retain its integrity during the cleaning process, particularly if the outdoor surface is not a substantially smooth surface. The scrubbing material 10 can be in the form of a pad and can be a one-layer, or a multi-layer structure. Suitable materials may include synthetics such as polyolefins, for example, polyethylene and polypropylene; polyesters; polyamides; synthetic cellulosics such as RAYON; and blends thereof. In an embodiment, the scrubbing material 10 of the cleaning element may include any conventional abrasive known in the art for use in cleaning or scrubbing, such as but not limited to silica.

In an embodiment, wherein the cleaning element includes a scrubbing layer 10 and an absorbent layer 9, the scrubbing layer 10 may be capable of passing liquid, such as the cleaning fluid and/or soils, through to the absorbent layer 9 so that the scrubbing layer 10 will have capacity to continually remove soil from the outdoor surface. In this embodiment, the scrubbing layer 10 may contain openings (e.g., slits) that provide a means for larger particulate matter to pass through the scrubbing layer 10 and into the absorbent layer 9. Low density structures may be used for the scrubbing layer 10 to facilitate the passing through of particulate matter to the absorbent layer 9.

As shown in FIG. 3, the scrubbing layer 10 comprises a material that has the ability to conform to the irregularities of the outdoor surface.

In the embodiment shown in FIG. 4, the cleaning element 3 includes one or more bundles or groups of bristles 13 extending out of the plane of the scrubbing layer 10 for cleaning outdoor surfaces. In the embodiment of FIG. 4, the cleaning element 3 includes a first scrubbing layer 10 which is in contact with the surface to be cleaned, a second absorbent layer 9 at least partially connected to the scrubbing layer 10, and a group of bristles 13 extending out of the plane of the scrubbing layer 10. This embodiment is particularly suitable for use with outdoor surfaces having opposed surfaces which may be spaced apart by a gap, for example, a plurality of flat, elongated members assembled as a deck. The bristles may be natural bristles and/or filaments made of flexible synthetic polymer material such as a polyamide, for example various types and grades of nylon or other similar material. In an embodiment, the bristles may be grouped in a manner such that they contour to the surface of the flat elongated members assembled as a deck.

The cleaning apparatus further includes a liquid delivery system in fluid communication with the cleaning element and/or the outdoor surface. In the embodiment shown in FIG. 1, the liquid delivery system includes a reservoir 6 for storing and/or dispensing the cleaning fluid and, a tube 7 to transfer cleaning fluid from the reservoir 6 to the cleaning element 3 and/or the outdoor surface. The liquid delivery system is typically attached to the handle 1. The reservoir 6 may comprise any suitable material such as but not limited to plastic or metal. The cleaning fluid may be poured from its container into the reservoir 6. In an embodiment, the reservoir 6 may hold the cleaning fluid container such that the container with cleaning fluid therein, e.g., cartridge, can be placed directly into the reservoir 6. The cleaning fluid may be withdrawn from the reservoir 6 and delivered to the cleaning element 3 or directly to the surface to be cleaned by means of the tube 7. The tube 7 may include any suitable flexible material. In an embodiment, a standard fluid delivery valve (not shown) may be connected to the reservoir 6, tube 7 and/or the handle 1 in a manner such that moving the valve in the open position would allow the cleaning fluid to flow from the reservoir 6 through the tube 7, and moving the valve in the closed position would stop the flow of the cleaning fluid. In a further embodiment, standard control means (not shown) may be connected to the reservoir 6, tube 7 and/or handle 1 to regulate the flow of cleaning fluid.

The cleaning fluid may flow through the tube 7 as a result of gravity. In an alternate embodiment, the cleaning fluid may be pressure fed through the tube 7 by means of, for example, a standard hand pump or battery operated pump (not shown). In a further embodiment, pressure application of the cleaning fluid to the outdoor surface to be cleaned may be provided by water pressure. In an embodiment, the handle 1 or the tube 7 of the cleaning apparatus may include an opening wherein a hose, e.g., garden hose, may be connected. In an embodiment, one end of the hose is connected to a water source and the other end to the tube of the cleaning apparatus. The water flows through the hose and into the tube 7. The water mixes with the cleaning fluid which is dispensed from the reservoir 6 and then flows to the cleaning element 3 or directly to the outdoor surface to be cleaned. In alternate embodiments, the reservoir 6 may contain a liquid or powder cleaning concentrate. The cleaning concentrate may be dispensed from the reservoir 6 and combined with the water from the hose to produce a cleaning fluid that may be dispensed through the tube 7 to the cleaning element 3 or the outdoor surface to be cleaned. In another embodiment, a second fluid transfer tube (not shown) may be connected from the hose to the cleaning element or the outdoor surface to be cleaned.

In an embodiment, the tube 7 may be connected to the cleaning element 3 such that the cleaning element 3 is wetted with cleaning fluid. In another embodiment, the tube 7 may be connected such that the cleaning fluid is delivered directly to the outdoor surface to be cleaned. In this embodiment, a standard spray nozzle (not shown) may be connected in the vicinity of the cleaning element 3. For example, the spray nozzle may be connected to the handle 1 or the support head 4 which connects the cleaning element 3 to the handle 1. In this embodiment, the cleaning fluid passes through the nozzle and the spray is directed away from the support head 4, in front of the cleaning element 3 and directly to the outdoor surface to be cleaned. In this embodiment, the outdoor surface is wetted by the cleaning fluid and the cleaning element 3 is wiped over the wetted surface. Attachment of the spray nozzle to the support head 4 may allow for increased directional control of the spray nozzle. The spray nozzle may be connected to the handle 1 or support head 4 using conventional means such as but not limited to clamps, hooks, adhesive, related hardware and the like.

In an embodiment, the handle 1 may include a mechanism, such as a conventional trigger (not shown), connected to the reservoir 6 and/or the tube 7 to release and/or control the flow of cleaning fluid from the reservoir 6 into the tube 7 and subsequently to the cleaning element 3 and/or outdoor surface.

The cleaning fluid for use in the present invention can be selected from any conventional cleaning fluids that are known in the art for use on outdoor surfaces. The cleaning fluid may be water-based solutions or solvent-based solutions. In an embodiment, the cleaning fluid may be a liquid concentrate or solid concentrate wherein the end-user adds water to form a solution. The solid concentrate can be, for example, in the form of a powder, tablet, brick and the like, and should be dissolvable in water and/or solvent. The cleaning fluid may also include other additives conventionally added to such cleaning fluids, including surfactants, viscosity agents, anti-foam agents, enzymes and the like. A biocide, fungicide and/or anti-microbial material may also such as silver nitrate, for example. Suitable cleaning fluids for use in the present invention may be bleach-based or non-bleach-based such as soap-based, for example. A non-limiting example of a commercially available product may include OLYMPIC Deck Cleaner 52125 from Pittsburgh Architectural Finishes.

Any outdoor surface can be cleaned using the apparatus of the present invention. The present invention is also directed to a method of cleaning outdoor surfaces, including but not limited to surfaces comprising wood, polymeric materials such as wood composite or plastic composite materials, cement, asphalt; and the like. In an embodiment, the outdoor surface can be a patio or a deck that contains a plurality of relatively flat, elongated surfaces comprising wood or polymeric material wherein at least some of the flat, elongated members have opposed surfaces spaced apart by a gap. Besides decks, the method of the invention may be used to clean railings, fences, outdoor furniture, and the like.

Whereas particular embodiments of this invention have been described above for purposes of illustration, it will be evident to those skilled in the art that numerous variations of the details of the present invention may be made without departing from the invention as defined in the appended claims. Unless otherwise indicated, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, “a” scrubbing layer can include more than one scrubbing layer, or “an” absorbent layer can include more than one absorbent layer, or “a” tube can include more than one tube.

We claim:

1. An apparatus for cleaning an outdoor surface comprising:
a) a handle;
b) a removable cleaning element mounted on one end of the handle structured and arranged to clean the outdoor surface comprising an absorbent layer and a scrubbing layer covering at least a portion of the absorbent layer;
c) a reservoir for storing cleaning fluid mounted on the handle; and
d) a tube in fluid communication between the reservoir and the removable cleaning element.

2. The apparatus of claim 1 wherein the scrubbing layer comprises polyolefin, polyester, polyamide, synthetic cellulosics and blends thereof.

3. The apparatus of claim 1 wherein the absorbent layer comprises water-insoluble, water-swellable polymers.

4. The apparatus of claim 1, further comprising bristles extending from a lower surface of the removable cleaning element.

5. The apparatus of claims 4, wherein the bristles comprise a polymeric material.

6. The apparatus of claim 1 in which the reservoir houses a cartridge containing cleaning fluid.

7. A method for cleaning an outdoor surface comprising:
a) applying a cleaning fluid to the outdoor surface to be cleaned; and
b) wiping the outdoor surface with a cleaning apparatus that comprises a handle and a removable cleaning element,
wherein the cleaning fluid is applied by a liquid delivery system in fluid communication with the cleaning element.

8. The method of claim 7 wherein the cleaning fluid is delivered to the cleaning element.

9. The method of claim 7 wherein the cleaning fluid is delivered directly to the outdoor surface.

10. The method of claim 7 wherein the cleaning fluid comprises an aqueous solution.

11. The method of claim 7 wherein the cleaning element comprises two layers.

12. The method of claim 11 wherein the cleaning element comprises a scrubbing layer and an absorbent layer.

13. The method of claim 7 wherein the liquid delivery system comprises a reservoir and tube.

14. The method of claim 7 wherein the outdoor surface comprises a plurality of relatively flat, elongated members wherein at least some of the flat, elongated members have opposed surfaces spaced apart by a gap or attached by a groove, the cleaning element further comprising:
a plurality of bristles extending outwardly from the cleaning element and contacting the flat elongated members.

15. The method of claim 14 wherein the members comprise wood.

16. The method of claim 14 wherein the members comprise a polymeric material.

17. The system of claim 14 wherein the bristles comprise a polymeric material.

18. The method of claim 14 wherein the members are assembled as a deck.
